(19) United States
(12) Patent Application Publication
(10) Pub. No.: US 2017/0086035 A1
(43) Pub. Date: Mar. 23, 2017

(54) ESTABLISHING A GROUP BASED ON AUDIO SIGNALLING

(71) Applicant: CRUNCHFISH AB, Malmö (SE)

(72) Inventors: Carl Tönsgård, Malmö (SE); Joakim Nydemark, Malmö (SE); Paul Cronholm, Malmö (SE)

(21) Appl. No.: 15/126,302

(22) PCT Filed: Mar. 17, 2015
(86) PCT No.: PCT/SE2015/050296

§ 371 Date: Sep. 15, 2016

(30) Foreign Application Priority Data
Mar. 17, 2014 (SE) 1450293-4

(51) Int. Cl. H04W 4/08; H04L 29/08; H04W 4/20

(52) U.S. Cl. CPC H04W 4/08; H04W 4/206; H04L 67/06; H04W 84/12

(57) ABSTRACT

This application relates to an improved manner of establishing or identifying a subgroup of users, which users belong to a larger group, and each user having a computing device, by providing a network comprising a first and a second computing device. The first computing device being configured to send out a detectable signal and the second computing device being configured to register said signal whereby a computing device subgroup is established comprising said first computing device and said second computing device.

### TECHNICAL FIELD

This application relates to an improved manner of establishing or identifying a subgroup of users, which users belong to a larger group.

### BACKGROUND

In many workplaces or social networks, it is common that all members (or employees) are members of the same group. To implement different groups of interest (such as different levels of clearance for example) subgroups may be formed.

These groups are usually defined by a system manager and stored in the system. Examples of such systems are email clients. This enables information to be shared to all members of a group or a subgroup.

Sometimes there is a need for an ad hoc group to be formed. This requires that a user (preferably the system manager) to pen the communication client and define the group. Such defining of a group takes a long time and is cumbersome to make, especially if the subgroup is only a temporary one, such as when sharing a file in a meeting to the participants of the meeting.

### SUMMARY

It is an object of the teachings of this application to overcome the problems listed above by providing a network comprising a first and a second computing device, wherein said first computing device being configured to send out a signal, for example by playing an audio tune, the audio tune being the signal, and

said second computing device being configured to detect said signal whereby a computing device subgroup is established comprising said first computing device and said second computing device.

Such a network is enabled to identify a subgroup of users in a larger group quickly and easily without the users having to manually input data to define a group or perform extensive pairing operations.

A method and a computer-readable medium carrying instructions for executing the method are also part of the teachings herein.

The teachings herein find use in devices such as mobile phones, smart phones, tablet computers, computers (portable and stationary), gaming consoles and media and other infotainment devices.

### BRIEF DESCRIPTION OF DRAWINGS

The invention will be described in further detail under reference to the accompanying drawings in which:

FIGS. 1A and 1B are schematic views of each a computing device according to the teachings herein;

FIG. 1C is a schematic view of the components of a computing device according to the teachings herein;

FIG. 2 is a schematic view of a network according to the teachings herein; and

FIG. 3 is a time graph for a network according to the teachings herein.

### DETAILED DESCRIPTION

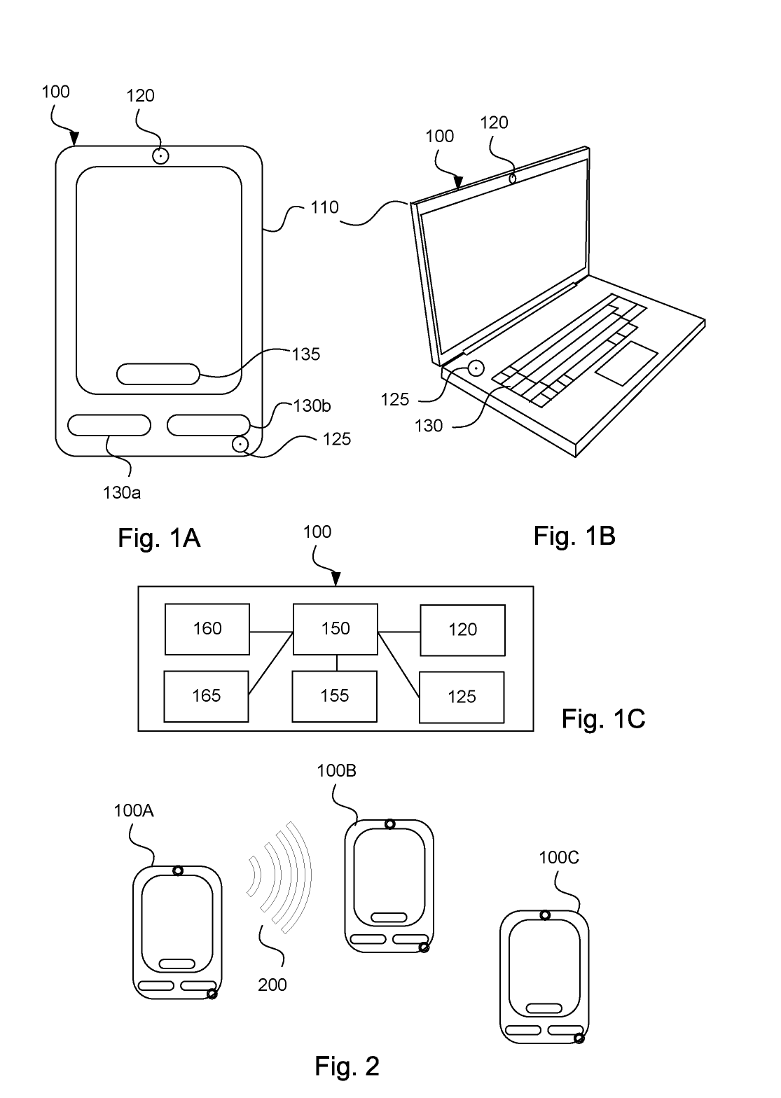

FIG. 1 generally shows a computing device 100 according to an embodiment herein. In one embodiment the computing device 100 is configured for network communication, either wireless or wired. Examples of a computing device 100 are: a personal computer, desktop or laptop, an internet tablet, a mobile communications terminal such as a mobile telephone, a smart phone, a personal digital assistant and a game console. Two embodiments will be exemplified and described as being a smartphone in FIG. 1A and a laptop computer 100 in FIG. 1B. The computing device 100 comprises a controller for controlling the action of the computing device and a memory for storing instructions and data such as files and audio tunes.

Referring to FIG. 1A a mobile communications terminal in the form of a smartphone 100 comprises a housing 110 in which a display is arranged. Furthermore, the smartphone 100 comprises a number of keys 130a, 130b and a virtual key 135.

The smartphone 100 is also equipped with a loud speaker 120 and a microphone 125. The smartphone 100 may further be equipped with a camera or other light sensing device.

Referring to FIG. 1B a laptop computer 100 comprises a display and a housing 110. The laptop computer 100 further comprises at least one input unit such as a keyboard 130. Other examples of input units are computer mouse, touch pads, touch screens or joysticks to name a few.

The laptop computer 100 is further equipped with a loud speaker 120 and a microphone 125. The laptop computer 100 may further be equipped with a camera or other light sensing device.

FIG. 1C shows a schematic view of a computing device 100, such as the smartphone of FIG. 1A or the laptop computer of FIG. 1B. The computing device 100 comprises a controller 150, which may be formed of one or more logical processing units (such as central processing units), connected to a memory 155 for storing instructions that control the operation of the computing device 100, when executed by the controller 150. The memory may also store data such as files to be shared or files received. The memory may comprise of one or more than one memory units.

The computing device 100 also comprises a user interface 160, and a radio frequency 165 interface such as a WiFi interface, a Bluetooth interface and/or a cellular communications interface such as a LTE (Long Term Evolution) interface.

The computing device 100 also comprises a signal receiver 120, such as a microphone, a camera or other light sensor, or a vibration sensor.

The computing device 100 also comprises a signal generator 125, such as a loudspeaker, a light, or a vibrator.

FIG. 2 shows a schematic view of a network according to herein. A number (in this example three) of computing devices 100A, 100B, 100C are connected to each other through a network. The network may be a WiFi network, a mesh network or a server controlled network such as an intranet, an internet based network or a cloud service.

The network may be controlled by a central server or access point (not shown).

As a computing device 100A wants to establish a subgroup the computing device 100A sends out a detectable signal 200. In a first embodiment the signal is an audio tune sent out or played through the loud speaker of the computing device 100A.

In other embodiments the signal may comprise background noise from the current location, an ultrasonic signal, a visible light or flash signal, an infrared light signal or a vibration sequence. The signal may in other embodiments be any type of signal possible for the first computing device 100A to emit, and for the second computing device 100B to register.

The signal may also comprise a combination of two or more of the above mentioned signals. In one embodiment the signal comprises an individual tone or other type of signal. In another embodiment the signal comprises a series of tones or other types of signals, i.e. a melody or a vibration pattern (compare with Morse code).

The signal is picked up only by the computing devices that are close to the first computing device 100A. In this example, the signal 200 is picked up by the second computing device 100B, but not the third computing device 100C.

When the signal comprises an audio tune, another computing device 100B, 100C may pick it up if it is located with in hearing range of the first computing device 100A.

If the signal comprises a light signal (visible or non-visible) the other computing devices 100B, 100C need to be within eyeshot of the first computing device 100A in order to register the signal, and preferably angled in a favourable direction.

If the signal is a vibration sequence the detection may be accelerometer based in that the other computing devices 100B, 100C may detect a certain combination of position changes. This requires that the computing devices 100A, 100B, 100C all need to be positioned e.g. on the same surface in order for the vibration signal to travel from the first computing device 100A to the other devices 100B, 100C intended to be part of the subgroup. The other computing devices 100B, 100C may also or alternatively detect the vibration by detecting the sound created by the vibration (for example when the first computing device is lying on a table). The other computing devices 100B, 100C may also or alternatively detect the vibration by detecting the vibration as propagated through a surface which both the first and the other computing device is lying or positioned on.

The described manner can be used to establish a subgroup of computing devices being in the same meeting room or generally close to one another.

Also, by sending out a signal that can be perceived by a user, the user is made aware of that a group is being established. In addition to serving as a feedback to the user(s), it also provides a malfunction detection. If the user can hear the signal, but this computing device does not indicate a group being established or receives any shared content, the user can quickly ascertain that a problem exists.

The group may be established temporarily for transferring a file or other content. In such an example, a file is to be shared by the first computing device 100A to the second computing device 100B, but not to the third computing device 100C. The file transfer is performed to the whole network, but with the condition that only those computing devices that can pick up the signal 200 actually fetches or stores the file to be shared.

The intended recipients of the file can thus be identified in a simple manner out of the whole group comprising all the computing devices of the group (for example all the computing devices in a company).

The computing device may be configured to always have the microphone active, trying to pick up the signal when it comprises an audio tune, or it may be prompted (possibly through the central controller/server) to activate the microphone.

The computing device may be configured to always have some kind of receiving sensor active, not necessarily the microphone, if the signal is based on a different property than sound. The receiving sensor may in one embodiment be a camera capable of registering signals based on light.

In another embodiment the receiving sensor may be a position sensor, for instance an accelerometer or any other position sensor which is known to the skilled person.

The receiving sensor may in another embodiment be a piezo element with the ability to register ultrasonic signals, or another sensor with the same abilities.

In one embodiment a combination of receiving sensors may be used, if the signal comprises several signal portions, for example both an audio part and an ultrasonic part.

In an embodiment where the detectable signal comprises an audio tune it may be a standard sound—or one of a group of standard audio tunes.

The audio tune may be generated specifically for the establishing of the group.

The audio tune may also be recorded through the microphone

The audio tune may reflect the background noise of the area. Should the background noise not be specific an audio tune as above can be chosen.

The audio tune may comprise an audible part and an ultrasonic part. The audible part indicates to the computing devices that are close by that an audio tune is being played and they should start interpreting the audio tune and the ultrasonic part comprise coded information about what group action is to be performed, such as a file to be transferred and/or a duration of the group).

The identity or the detectable signal may be provided to the whole network so that the computing devices know what to try to pick up.

The signal may be associated with the file. In such a case, the signal may be composed to reflect the file identity or the file may be associated with a specific signal by the first computing device which association is communicated to the central controller (or to the whole network).

A file may be transferred peer to peer or through the central controller.

In one embodiment, the receiving computing device is provided with an identifier for the file and requests the file from a server.

In one embodiment, the receiving computing device is provided with an identifier for the file and an identifier for the sending computing device and requests the file from the sending computing device.

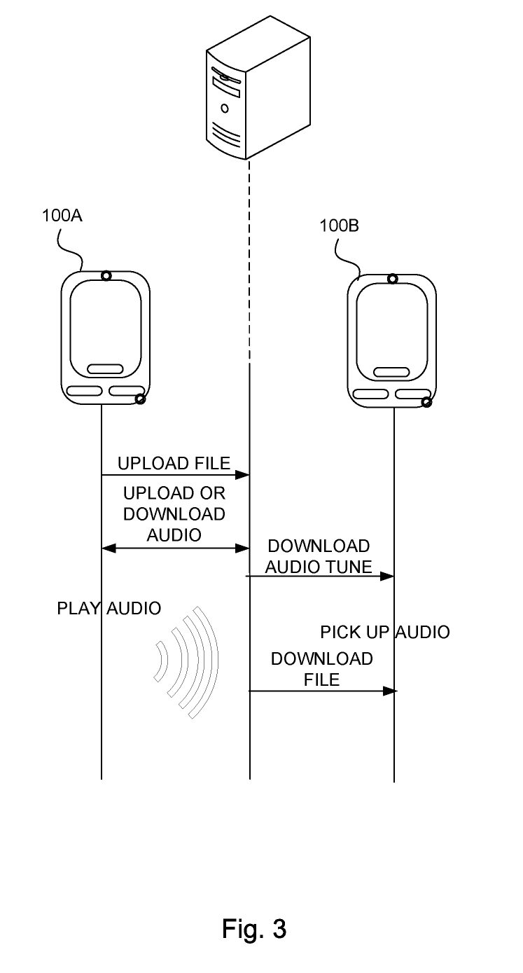

An identifier may be provided with the signal or it may be received from the first computing device through other short range communication, such as Bluetooth.One proposed flow is shown in FIG. 3. A first computing device 100A initiates a file transfer by uploading the file to a central controller (such as a server or WiFi access point). The central controller or the computing device assigns a signal, such as an audio tune to the file and communicates this to the computing device (in case the central controller assigns the signal) or to the central controller (in case the computing device assigns the signal).

The signal (or its identifier) is downloaded to the other members of the group.

The first computing device 100A sends out the signal which is picked up by a second computing device 100B. The second computing device 100B downloads the file. The file can also be downloaded directly from the first computing device 100A.

Alternatively the file is not associated with the signal and the second computing device 100B simply downloads the last uploaded file.

The signal may be associated with the file for a duration during which it is possible to download the file.

The duration of the established subgroup may also or alternatively be limited. During such a duration files that have been shared may be downloaded (unless the file is associated with a different duration).

In one embodiment the duration is a preset time, such as 10 seconds, 30 seconds, 1 minute, 5 minutes, 10 minutes, 15 minutes, 20, minutes, 30 minutes, 45 minutes or 1 hour or longer.

In one embodiment the duration equals a duration of a current meeting stored in a calendar application of the first computing device 100A.

In one embodiment, the duration is tied to a location and as a computing device is removed from that location, the computing device is removed from the group. If the first device is removed, then the group is cancelled.

In one embodiment, the duration is for the sharing of one specific file (or content) and as the file has been shared, the subgroup is cancelled or deactivated.

The signal may be selected to represent a current meeting room (fetched from a calendar) and thus does not need to be communicated to the members of the group. In such an embodiment, all computing devices having received the calendar event has also received information about which signal to detect.

The manner taught herein may also be used for connecting one device with another, and not necessarily to connect users. In one example the signal is used to select a printer for transferring a file to be printed.

This is one example of how to identify a sender for a recipient, when there are many different senders possible, such as when choosing which file to print as a printer receives a print command.

This has the benefit that a pairing or other complicated group definition is not necessary to be made with each computing device of the subgroup for establishing the subgroup.

Another example is to connect a device to a display or projector.

The computing device 100A may also be equipped with a camera for detecting and tracking an object, such as a hand, and to detect and identify gestures made by the tracked object. One such gesture may be to share a file. As the computing device discovers such a gesture it initiates file sharing or distribution according to above.

The computing device 100A may send out the signal 200 at certain intervals in order to maintain the subgroup. This enables for ensuring that computing devices that has left the area will no longer be able to receive shared content.

If another computing device 100B leaves the covered area it also leaves the subgroup. If, on the other hand, yet another computing device 100C enters the current area it will be included into the group a soon as it detects the signal.

This also serves to remind users that they are actively part of a sharing network.

1. A network comprising a first and a second computing device (100A, 100B), wherein said first computing device (100A) being configured to
Generate a signal,
send out said signal and
said second computing device (100B) being configured to
detect said signal whereby a computing device subgroup is directly established by said second computing device (100B) comprising said first computing device and said second computing device.

2. The network according to claim 1, wherein said signal comprises one of the following: an audio tune, a background noise, an ultrasonic signal, a light signal, an infra red light signal, a vibration sequence.

3. The network according to claim 1, wherein said first computing device is further configured to associate said signal with a file to be shared.

4. The network according to claim 1, wherein said first computing device is configured to select said signal from a group of standard audio tunes.

5. The network according to claim 1, wherein said first computing device is configured to select said signal as background sound.

6. The network according to claim 1, wherein said first computing device is configured to record said signal.

7. The network according to claim 1, wherein said first computing device is configured to receive an identifier for said signal.

8. The network according to claim 1, wherein said signal is associated with a locality.

9. The network according to claim 1, wherein said second computing device is configured to receive an indication of said signal.

10. The network according to claim 1, wherein said network is a WiFi-based network.

11. The network according to claim 1 whereby said second communication device (100B) downloads a file shared by said first communication device (100A).
